(19) United States
(12) Patent Application Publication
(10) Pub. No.: US 2025/0303498 A1
(43) Pub. Date: Oct. 2, 2025

(54) SEPARATING-JOINING DEVICE, METHOD FOR SORTING OUT DEFECTIVE COMPONENTS, AND USE OF A BEAM UNIT FOR THERMAL SEPARATION AND JOINING PROCESSES

(71) Applicant: JENOPTIK Optical Systems GmbH, Jena (DE)

(72) Inventors: Steffen REINL, Jena (DE); Roland FIEDLER, Jena (DE); Benedikt SCHNIZER, Jena (DE); Kay SCHILLING, Jena (DE); Robert KRUEGER, Jena (DE)

(73) Assignee: JENOPTIK Optical Systems GmbH, Jena (DE)

(21) Appl. No.: 18/865,291

(22) PCT Filed: Apr. 11, 2023
(86) PCT No.: PCT/EP2023/059432

§ 371 Date: Nov. 12, 2024

(30) Foreign Application Priority Data
May 10, 2022 (DE) 10 2022 111 646.8

(51) Int. Cl. B23K 26/24; B23K 26/38; B23K 37/047

(52) U.S. Cl. CPC B23K 26/24; B23K 26/38; B23K 37/047

(57) ABSTRACT

A separating-joining device to sort out a defective component from components arranged in a row on a support body. A thermal cutting unit thermally separates the support body. At least one welding unit thermally joins the support body. A cutting control unit being designed to automatically control the thermal cutting unit such that the support body is thermally separated at at least two ascertainable cutting interfaces of the support body via a beam of the cutting unit. At least one conveyor unit for arranging the two cutting interfaces of the two remaining parts of the support body next to each other in order to form a joining interface. A welding control unit to automatically control the welding unit such that the two remaining parts of the support body are joined at the joining interface via a beam of the welding unit.

### TECHNICAL AREA

The present invention relates to a separating-joining device, a method for sorting out a defective component, and the use of a beam unit for thermal separation and joining processes.

Components, such as metallic punched parts, can be arranged on a carrier body, such as a carrier strip, in a longitudinal direction of the carrier body in a row on the carrier body. Such a carrier body having a plurality of components can have defective components which are advantageously sorted out in order to be able to ensure a smooth operation during installation of the components

A punched strip production system having a mechanical separation of strip segments is known from DE 10 2021 112582 A1. Mechanical separating devices are subject to wear, are inaccurate, and are susceptible to breakdown. A punched strip manufacturing system having mechanical separation of strip segments is known from DE 10 2021 112262 A1. Devices for separating out a workpiece, which also work mechanically, are known from WO 2019/214855 A1, DE 20 2018 002305 A1, and DE 10 2018 003622 A1. Mechanical devices for mechanically cutting up the carrier body for sorting out the defective components can moreover require a large amount of installation space. Furthermore, the carrier body can only have limited accessibility for the mechanical cutting up, so that a mechanical device for mechanically cutting up the carrier body for sorting out the defective components only has limited capability in order to also separate out components arranged close to one another nondestructively. Moreover, changing over from one punched part to another component (so-called article change) in a mechanical device for mechanically cutting up the carrier body for sorting out the defective components can require a high level of refitting expenditure. Furthermore, mechanical devices can have a high level of wear and a high maintenance expenditure.

A laser punching device for high-speed cutting is known from EP 2 285 521 B. This is used for cutting a material reserve from a coil reserve and can also be used for welding.

A laser welding device for induction coils is known from CN 1 13 385 937 A, in which a feed and cutting mechanism is additionally provided.

### OBJECT OF THE INVENTION

It is the object of the present invention to at least partially eliminate the above-described disadvantages. In particular, it is the object of the present invention to provide a separating-joining device, which is particularly simply designed and/or requires little installation space and/or is precise and/or is low maintenance and/or is low wear, for separating and joining a carrier body in order to obtain a carrier body having perfect or substantially perfect components arranged in a row on the carrier body. Furthermore, it is the object of the present invention to provide a method in which defective components can be sorted out particularly advantageously in order to obtain a carrier body having perfect or substantially perfect components arranged in a row on the carrier body.

### ACHIEVEMENT OF THE OBJECT

The above-mentioned object is achieved by a separating-joining device having the features of claim 1 and a method having the features of claim 9 as well as the use of a single beam unit having the features of claim 16. Further features and details of the invention result from the dependent claims, the description, and the drawings. Features and details which are described in conjunction with the separating-joining device according to the invention itself-evidently also apply in conjunction with the method and/or the use of the beam unit according to the invention and vice versa in each case, so that reference can always be made mutually with respect to the disclosure to the individual aspects of the invention.

### DESCRIPTION

According to a first aspect, the present invention discloses a separating-joining device for separating and joining a carrier body, such as a carrier strip, wherein the separating-joining device is designed for sorting out, in particular for automated sorting out of at least one defective component from a plurality of components arranged in series on the carrier body in a longitudinal direction of the carrier body. The separating-joining device comprises at least one thermal ablation unit for thermal separation of the carrier body by means of at least one beam. In addition, the separating-joining device comprises at least one welding unit for thermal joining of the carrier body by means of at least one beam. In addition, the separating-joining device comprises an ablation supervision unit for supervising the thermal ablation unit, wherein the ablation supervising unit is designed to supervise the thermal ablation unit in an automated manner such that the carrier body is thermally separated at at least two definable separation interfaces of the carrier body for sorting out the at least one defective component in a separating mode of the thermal ablation unit by the beam of the thermal ablation unit. In addition, the separating-joining device comprises at least one drivable conveyor unit for moving the at least two remaining parts of the carrier body for a concatenation, in particular for an automated concatenation, of the two separation interfaces of the two remaining parts of the carrier body to form a joining interface of the two remaining parts of the carrier body. In addition, the separating-joining device comprises a welding supervision unit for supervising the welding unit, wherein the welding supervision unit is designed to supervise the welding unit in an automated manner such that the two remaining parts of the carrier body are thermally joined together at the joining interface by the beam of the welding unit in a joining mode of the welding unit.

In particular, the separating-joining device is designed for sorting out the at least one defective component or multiple defective components from a plurality of components arranged in series on the carrier body in the longitudinal direction of the carrier body, in order to obtain a carrier body having perfect components arranged on the carrier body by sorting out the at least one or more defective components. Therefore, for example, a smooth operation can be ensured during a later installation of the components.

The carrier body is in particular a plate-shaped carrier strip, in particular a plate-shaped endless strip. The carrier body can be formed from a metallic plate. The thermal separating and the thermal joining for sorting out a defective component arranged on the plate-shaped carrier strip can therefore be carried out particularly easily. The plate-shaped carrier strip can have, for example, a material thickness of 0.05 to 2.0 mm, in particular a material thickness of 0.1 to 1.0 mm, particularly advantageously less than 0.5 mm. In particular, the plurality of components arranged in series on the plate-shaped carrier strip in the longitudinal direction of the plate-shaped carrier strip is arranged at one longitudinal edge of the plate-shaped carrier strip. For example, the plate-shaped carrier strip having the plurality of components arranged at the longitudinal edge of the plate-shaped carrier strip can be created by punching a plate-shaped base body. Furthermore, the carrier body and the plurality of components arranged in series on the carrier body in the longitudinal direction of the carrier body can be integrally formed. The components can be punched parts, for example. Such punched parts can be, for example, costume jewelry elements, paper clips, contact springs, plug connectors, cable lugs, or also spoons or spinners for fishing. The components can be formed from the plate. The components can be formed by processing, for example, embossing, deep drawing, and/or bending or can be intended for forming after passing through the separating-joining device. The components can be coated, for example, anodized, nickel-plated, chromed, gilded, and/or painted.

In particular, adjacent components of the plurality of components arranged in series on the carrier body in the longitudinal direction of the carrier body each have the same or essentially the same distance. For example, the distance between two adjacent components can be 1 mm to 50 mm, in particular 2 mm to 30 mm. Because they have identical or essentially identical distance, the separating interfaces of the carrier body for sorting out the defective component can be defined particularly easily.

The thermal ablation unit in particular has a beam generating unit, such as a laser, in particular a nanosecond laser, for generating the beam for the thermal separation. Furthermore, the thermal ablation unit can have a focusing optical unit for focusing the beam, wherein in particular the focusing optical unit is arranged at a beam exit end of the thermal ablation unit, wherein furthermore in particular the beam exit end of the thermal ablation unit faces toward the carrier body having the components arranged on the carrier body. At the beam exit end of the thermal ablation unit, the beam exits from the thermal ablation unit toward a carrier body having the components arranged on the carrier body. It is also conceivable that the thermal ablation unit thermally separates the carrier body using multiple beams simultaneously. For example, a first beam of the thermal ablation unit can thermally separate a first separating interface of the carrier body and a second beam of the thermal ablation unit can thermally separate a second separating interface of the carrier body. The thermal separation can therefore take place particularly quickly. Furthermore, in particular a (first) optical sensor unit for optically detecting the at least two separating interfaces can be arranged on an arrangement interface formed on an outer lateral surface of the thermal ablation unit. Preferably, the (first) optical sensor unit is arranged on the outer lateral surface of the thermal ablation unit at the beam exit end of the thermal ablation unit. Monitoring the beam and/or supervising the beam and/or checking the at least two separating interfaces can therefore take place particularly easily and accurately.

The welding unit comprises in particular a beam generating unit, such as a laser, in particular a nanosecond laser, for generating the beam for the thermal joining. Furthermore, the welding unit can have a focusing optical unit for focusing the beam, wherein in particular the focusing optical unit is arranged at a beam exit end of the welding unit, wherein in particular the beam exit end of the welding unit faces toward the carrier body having the components arranged on the carrier body. At the beam exit end of the welding unit, the beam exits from the welding unit toward the carrier body having the components arranged on the carrier body. It is also conceivable that the welding unit thermally joins the carrier body using multiple beams simultaneously. For example, a first beam of the welding unit can thermally join a welding interface of the carrier body and a second beam of the welding unit can simultaneously thermally join the first joining interface of the carrier body. The thermal joining of one or more joining interfaces can therefore take place particularly quickly. Furthermore, in particular a (second) optical sensor unit for optically detecting the at least one joining interface can be arranged at an arrangement interface formed on an outer lateral surface of the welding unit. Preferably, the (second) optical sensor unit is arranged at the outer lateral surface of the welding unit at the beam exit end of the welding unit. Monitoring the beam and/or supervising the beam and/or checking the at least one joining interface can therefore take place particularly easily and accurately.

Details and/or features and/or advantages which are mentioned in the preceding paragraphs and the following paragraphs with respect to the thermal ablation unit can also be transferred (analogously) to the welding unit and/or can be transferred (analogously) to the beam unit for thermally separating and thermally joining, and vice versa in each case, in particular provided that this is technically reasonable.

In particular, the ablation supervision unit and the thermal ablation unit for the supervision of the thermal ablation unit have a communication connection to one another. The welding unit and the welding supervision unit also have a communication connection to one another, in particular for the supervision of the welding unit. Furthermore, the ablation supervision unit and the welding supervision unit can have a communication connection to one another for the exchange of information. Separating or joining of the carrier body can therefore take place particularly advantageously.

The supervision of the thermal ablation unit by the ablation supervision unit is in particular a control of the thermal ablation unit and/or in particular the supervision of the welding unit by the welding supervision unit is in particular a control of the welding unit.

In particular, in the separating mode of the thermal ablation unit, the beam of the thermal ablation unit is furthermore at least temporarily pulsed. The thermal separation can therefore take place particularly advantageously, since separation is carried out layer by layer of the carrier body at a separating interface of the carrier body. For example, the thermal separation can be sublimation laser cutting using a pulsed laser beam, wherein in particular the laser is a nanosecond laser. In particular, the carrier body vaporizes layer by layer during the sublimation laser cutting.

In particular, the beam of the welding unit is at least temporarily continuous and/or quasi-continuous in the joining mode of the welding unit. The beam can be provided by a laser beam source, which is operable in the continuous wave mode (cw mode) and/or in the quasi-continuous wave mode (qcw mode). In the quasi-continuous wave mode, the pulse duration can advantageously be between 0.1 μs and 0.1 seconds, particularly advantageously more than 1 μs. The thermal joining can therefore take place particularly easily. However, it is alternatively or additionally also conceivable that the beam is at least temporarily pulsed in the joining mode of the welding unit. Furthermore, it is additionally conceivable that the beam at least temporarily executes a curved movement around the joining interface in the joining mode of the welding unit. For example, the beam, in particular a laser beam, of the welding unit can at least temporarily execute a pulsed wobbling movement, a zigzag movement, a figure eight-movement, or a double figure-eight movement along the joining interface. The welding area can be enlarged by the execution of a curved movement or a wobbling movement. In a further embodiment, it can be advantageous to carry out the welding and the separating using the same pulsed laser. The welding can then also take place in a pulsed mode. The welding can advantageously take place on a butt joint or with a gap, which can advantageously be smaller than the thickness of the carrier body. In another embodiment, the welding can take place with overlap.

In particular, the carrier body is thermally separated or divided by the thermal separation (severing) by means of the beam of the thermal ablation unit at the at least two definable separating interfaces of the carrier body for sorting out the at least one defective component into a first remaining part having at least one (perfect) component arranged on the first remaining part, into a second remaining part having at least one (perfect component) arranged on the second remaining part, and into a reject part, arranged between the first remaining part and the second remaining part, having at least one defective component arranged on the reject part, wherein the reject part having the defective component is sorted out by the thermal separation of the carrier body at the separating interfaces. For example, after the thermal separation of the carrier body at the two separating interfaces, the reject part having the defective component falls into a collection container arranged spatially below the carrier body for sorting out the reject part having the defective component. After the sorting out of the reject part, the first remaining part and the second remaining part (thus the two remaining parts of the carrier body) having the respective separating interface can be arranged against one another by the at least one drivable conveyor unit in order to form a joining interface. In other words, in particular defective components are to be removed on the carrier body, in particular removed in an automated manner, and the carrier body separated for this purpose is to be joined together again.

The at least two separating interfaces are in particular each a straight-line separating interface. The thermal separation at a separating interface and the thermal joining at a joining interface can therefore take place particularly easily. In particular, the at least two remaining parts of the carrier body each have a front side, wherein the first remaining part is arranged with the front side against the front side of the second remaining part to form the joining interface. Therefore, the two remaining parts can be arranged against one another particularly precisely and without a gap or essentially without a gap at the joining interface and the carrier body can be joined particularly advantageously at the joint.

Using the beam of the thermal ablation unit for the thermal separation of the carrier body at separating interfaces of the carrier body and using the beam of the welding unit for the thermal joining of the carrier body at joints of the carrier body, separating interfaces and joining interfaces which are difficult to access can advantageously be reached particularly easily and/or the wear of the separating-joining device for the thermal separation and thermal joining is particularly low and/or the refitting expenditure in the event of a component (article) change is particularly low.

It can be advantageous if, in a separating-joining device according to the invention, the ablation supervision unit and the welding supervision unit are the same supervision unit, and wherein the thermal ablation unit and the welding unit are the same beam unit, wherein the beam unit is switchable at least between the separating mode for the thermal separation of the carrier body and the joining mode for the thermal joining of the carrier body. In other words, the separating-joining device can have a single beam unit for the thermal separation of the carrier body by means of a beam and for the thermal joining of the carrier body by means of a beam as well as a single supervision unit for supervising the beam for the thermal separation or the thermal joining. The installation space required for a separating-joining device according to the invention can therefore be particularly small and/or the maintenance expenditure can be kept particularly low. For example, after the thermal separation of the carrier body at the at least two defined separating interfaces of the carrier body, the two separating interfaces of the two remaining parts can be arranged against one another by means of the conveyor unit to form the joining interface in order to subsequently be thermally joined by means of a beam of the beam unit. The beam unit can have a beam generation unit, such as a laser, in particular a nanosecond laser, for generating the beam for the thermal separation or the thermal joining. Furthermore, the beam unit can have a focusing optical unit for the focusing of the beam, wherein in particular the focusing optical unit is arranged at a beam exit end of the beam unit, wherein in particular the beam exit end of the beam unit faces toward the carrier body having the components arranged on the carrier body. At the beam exit end of the beam unit, the beam exits from the beam unit toward the carrier body having the components arranged on the carrier body. It is also conceivable that the beam unit thermally separates and/or thermally joins the carrier body using multiple beams simultaneously. For example, a first beam of the beam unit can thermally separate a first separating interface of the carrier body and a second beam of the beam unit can thermally separate a second separating interface of the carrier body. The thermal separation or joining of one or more separating interfaces or joining interfaces can therefore take place particularly quickly. Furthermore, in particular an optical sensor unit for optically detecting the separating interfaces or the at least one joining interface can be arranged at an arrangement interface formed on an outer lateral surface of the beam unit. Preferably, the optical sensor unit is arranged at the outer lateral surface of the beam unit at the beam exit end of the beam unit. Therefore, monitoring of the beam and/or supervision of the beam and/or checking of the at least one joining interface can take place particularly easily and accurately.

In a separating-joining device according to the invention, the ablation unit can advantageously be a laser ablation unit, wherein the thermal separation of the carrier body at the at least two separating interfaces of the carrier body is carried out in each case by means of a laser beam and/or the welding unit is a laser welding unit, wherein the thermal joining of the carrier body at the joining interface formed by the two remaining parts is carried out by means of a laser beam. Therefore, even separating interfaces and joining interfaces which are difficult to access can be reached particularly easily. The thermal separation by means of a laser beam can also be understood as laser cutting. In particular, a pulsed nanosecond laser can be used in a sublimation cutting method for the thermal separation. The thermal separation can therefore be particularly advantageous. The thermal separation preferably takes place in a processing field of 90×90 mm. The thermal joining by means of a laser beam can also be understood as laser welding. In particular, a nanosecond laser in a pulsed wobble laser method can be used for the laser welding. The thermal joining by means of a laser beam can therefore take place particularly advantageously. Furthermore, the thermal joining can take place in a processing field of 90×90 mm. In addition, the thermal separation by means of a laser beam takes place without protective gas and/or the thermal joining by means of a laser beam takes place without protective gas. The thermal separation or the thermal joining by means of a laser beam can therefore be particularly easy. Alternatively, it is also conceivable that the thermal separation of the carrier body at the at least two separating interfaces of the carrier body is carried out by means of an electron beam and/or that the thermal joining of the carrier body at the joining interface formed by the two remaining parts is carried out by means of an electron beam, in particular without protective gas.

In a separating-joining device according to the invention, the separating-joining device can particularly advantageously have a first clamping unit for clamping the carrier body for the thermal separation of the carrier body at the at least two separating interfaces of the carrier body for the sorting out of the at least one defective component and/or the separating-joining device can have a second clamping unit for clamping the carrier body for the thermal joining at the joining interface formed by the two remaining parts, wherein in particular the first clamping unit and the second clamping unit are the same clamping unit. The thermal separation or the thermal joining can take place in a particularly error-free and exact manner due to the clamping. If the thermal ablation unit and the welding unit are the same beam unit, the beam unit preferably has a single clamping unit.

According to a further preferred embodiment, in a separating-joining device according to the invention, the thermal ablation unit can have a first optical sensor unit for optically detecting the at least two separating interfaces, wherein the ablation supervision unit is furthermore designed to supervise the beam of the thermal ablation unit for the thermal separation with the aid of the first optical sensor unit and/or to monitor the beam for the thermal ablation unit with the aid of the first optical sensor unit and/or to check the at least two separating interfaces with the aid of the first optical sensor unit and/or the welding unit can have a second optical sensor unit for optically detecting the joining interface formed by the two remaining parts, wherein the welding supervision unit is furthermore designed to supervise the beam of the welding unit with the aid of the second optical sensor unit and/or to monitor the beam of the welding unit with the aid of the second optical sensor unit and/or to check the joint formed by the two remaining parts with the aid of the second optical sensor unit, wherein in particular the first optical sensor unit and/or the second optical sensor unit are the same optical sensor unit. Details and/or features and/or advantages which are mentioned in the preceding paragraphs and the following paragraphs with respect to the first optical sensor unit of the ablation unit can also be transferred (analogously) to the second optical sensor unit of the welding unit and/or transferred (analogously) to the optical unit of the beam unit, and vice versa in each case. The first optical sensor unit of the thermal ablation unit can be a camera, for example. In particular, the first optical sensor unit of the thermal ablation unit furthermore has a communication connection to the ablation supervision unit for the supervision of the beam of the thermal ablation unit for the thermal separation and/or for the monitoring of the beam of the thermal ablation unit and/or for the checking of the separating interfaces. The supervision of the beam and/or the monitoring of the beam and/or the checking of the separating interfaces (or the joining interfaces) can in particular be carried out by means of an image processing function by the ablation supervision unit or the welding supervision unit or the supervision unit for supervising the beam unit. The thermal separation and/or the thermal joining can therefore take place particularly advantageously.

It can be advantageous if, in a separating-joining device according to the invention, the separating-joining device has a component sensor device for detecting at least the plurality of components arranged in series in the longitudinal direction of the carrier body for ascertaining the at least one defective component. The at least one defective component can therefore be ascertained particularly easily. For example, the component sensor device can have an optical sensor, such as a camera, for optically detecting at least the plurality of components arranged in series in the longitudinal direction of the carrier body, wherein the at least one defective component is ascertained in particular by means of an image processing function, for example by an image comparison. Furthermore, in particular the component sensor device has a communication connection to the ablation supervision unit and/or the welding supervision unit or the supervision unit for the supervision of the beam unit. Information, such as the position, about the at least one defective component or about multiple defective components can therefore be communicated.

In a separating-joining device according to the invention, the separating-joining device can advantageously have a removal unit, in particular a pneumatic removal unit, for removing the carrier body part separated at the two separating interfaces together with the defective component arranged on the carrier body part. The removal or the sorting out of the at least one defective component after the thermal separation can therefore be particularly advantageously ensured. The carrier body part can also be understood as the reject part of the carrier body. The pneumatic removal unit is preferably arranged above the carrier body having the components, so that a defective component can be transferred together with the carrier body (reject part) particularly easily into a collection container for collecting the reject parts. In particular, the removal unit can be arranged at the outer lateral surface of the thermal ablation unit at the beam exit end of the thermal ablation unit or at the outer lateral surface of the beam unit at the beam exit end of the beam unit. The removal or sorting out can therefore take place particularly easily. With components made of steel, a magnetic removal unit can also advantageously be used. In a further advantageous embodiment, the removal unit can be implemented by means of gravitation by falling down of the parts. In a further embodiment, a mechanical removal unit can be provided, in which the defective component can, for example, be safely removed using a gripper or can be knocked away by means of a momentum transfer hammer, in order to remove it safely. In a further advantageous embodiment, the removal unit can assist the removal of the defective component by means of a shaking movement, sound, or ultrasound.

In a separating-joining device according to the invention, the at least one drivable conveyor unit can particularly advantageously have at least one normal mode and one concatenation mode, wherein the at least one drivable conveyor unit in the normal mode moves the carrier body having the components arranged in series on the carrier body in the longitudinal direction of the carrier body in an advancing direction, and wherein the at least one drivable conveyor unit is designed to move the two remaining parts of the carrier body toward one another to form the joining interface in the concatenation mode. The drivable conveyor unit can therefore be used both for advancing the carrier body and for concatenating the two remaining parts after the thermal separation of the carrier body for the thermal joining of the two remaining parts at the joining interface. The separating-joining device can therefore be designed particularly simply. For example, the drivable conveyor unit can have at least two drives controllable independently of one another, wherein, in particular in the normal mode of the drivable conveyor unit, the drives controllable independently of one another move the carrier body in a common advancing direction and wherein, in the concatenation mode of the drivable conveyor unit, the drives controllable independently of one another move the two remaining parts toward one another.

According to a second aspect, the present invention discloses a method for sorting out at least one defective component from a plurality of components arranged in series on the carrier body in a longitudinal direction of the carrier body. The method has as one step ascertaining the at least one defective component from the plurality of components arranged in series on the carrier body in the longitudinal direction of the carrier body, wherein in particular the ascertainment is carried out by means of a component sensor device. The method comprises as a further step automatically defining at least two separating interfaces of the carrier body based on the at least one defective component, wherein in particular the defining of the at least two separating interfaces is carried out by means of a welding supervision unit or a supervision unit for supervising the beam unit. The method comprises as a further step automated thermal separating of the carrier body at the at least two defined separating interfaces of the carrier body to sort out the at least one defective component by means of a beam, wherein in particular the thermal separation is carried out by means of a thermal ablation unit or a beam unit.

The method comprises as a further step concatenating the two separating interfaces of the at least two remaining parts of the carrier body to form at least one joining interface of the two remaining parts of the carrier body, wherein in particular the concatenation is carried out by means of a drivable conveyor unit. The method comprises as a further step automated thermal joining of the two remaining parts of the carrier body at the formed joining interface by means of a beam, wherein in particular the thermal joining is carried out by means of a welding unit or a beam unit.

The method steps described above and hereinafter can be executed, if technically reasonable, individually, together, once, repeatedly, chronologically in parallel, and/or in succession in any order.

In particular, the two remaining parts of the carrier body are joined with one another along the entire formed joining interface. The carrier body is therefore particularly stable again after the thermal joining at the joining interface.

It can be advantageous if, in a method according to the invention, adjacent components of the plurality of components arranged in series on the carrier body in the longitudinal direction of the carrier body, each have the same or substantially the same distance, wherein the at least two separating interfaces of the carrier body are defined based on the ascertained defective component such that after the thermal joining of the carrier body at the joining interface formed by the two remaining parts, adjacent components still each have the same or substantially the same distance. A smooth operation can therefore be ensured during a later installation of the components. In particular, the carrier body can furthermore additionally have recesses spaced apart uniformly from one another for a movement of the carrier body in an advancing direction of the carrier body, wherein additionally the at least two separating interfaces of the carrier body are defined based on the ascertained defective component such that after the thermal joining of the carrier body at the joining interface formed by the two remaining parts, the carrier body still has recesses spaced apart uniformly from one another for the movement of the carrier body in the advancing direction. Due to the recesses in the carrier body, the movement of the carrier body can be carried out particularly easily by means of one or more pin wheels of a conveyor unit of a separating-joining device.

In a method according to the invention, the at least two separating interfaces of the carrier body can advantageously be defined based on the ascertained defective component such that only the carrier body having the defective component arranged on the carrier body is thermally separated out. Unnecessary additional separating out of perfect components in addition to the ascertained defective component is therefore avoided. In particular, it is particularly advantageously possible by means of an optical sensor unit for optically detecting the at least two separating interfaces that only the carrier body having the defective component arranged on the carrier body is thermally separated out.

In a method according to the invention, the carrier body can particularly advantageously be thermally joined at the joining interface formed by the two remaining parts by means of a curved movement, in particular a wobbling movement or a zigzag movement, of the beam. The welding area can therefore particularly advantageously be made large and the joint can be particularly stable.

According to a further preferred embodiment, in a method according to the invention, the beam for the thermal separation of the carrier body at at least one of the two defined separating interfaces can at least temporarily be a pulsed beam and/or the beam for the thermal joining at the joining interface formed by the two remaining parts is at least temporarily a continuous beam and/or is at least temporarily a pulsed beam moved in a curve along the joining interface. The beam for the thermal separation of the carrier body at the two defined separating interfaces of the carrier body is preferably a pulsed beam in each case. The thermal separation can be carried out particularly advantageously using a pulsed beam, since the carrier body is removed layer by layer at a separating interface of the carrier body. The thermal joining can be carried out particularly easily using the continuous beam. The welding area can advantageously be enlarged by the execution of the curved movement.

It can be advantageous if in a method according to the invention multiple defective components are thermally separated out of the components arranged in series on the carrier body in the longitudinal direction of the carrier body by thermal separation of the carrier body at defined separating interfaces of the carrier body, wherein chronologically after the separating out of the multiple defective components, the carrier body is thermally joined at multiple joining interfaces. Therefore, for example, with a (single) beam unit, which is responsible for the thermal separation of the carrier body and also for the thermal joining of the carrier body, continuous switching between the joining mode and the separating mode can be avoided. In particular, the supervision unit switches the separating-joining device between the joining mode and the separating mode. The switching between the separating mode and the joining mode is in particular software switching.

It can be advantageous if in a method according to the invention for the thermal separation, at least the carrier body is clamped for a stabilization of the carrier body and/or for the thermal joining of the carrier body it is clamped for a stabilization of the carrier body.

It can furthermore be advantageous if in a method according to the invention, after the thermal separation of the carrier body at the two separating interfaces, action is additionally taken on the separated-out carrier body part having the defective component, in particular pneumatic action is taken. The removal of the defective component with the carrier body part can therefore take place particularly safely.

It can furthermore be advantageous if in a method according to the invention for forming the joining interface, the two remaining parts are locked, where in particular the locking of the two remaining parts is carried out by means of a locking unit of the separating-joining device. The thermal joining at the joining interface formed by the two remaining parts of the carrier body can therefore take place particularly precisely.

It can furthermore be advantageous if in a method according to the invention, the automated thermal separation of the carrier body at the at least two defined separating interfaces of the carrier body for sorting out the at least one defective component is carried out by means of a beam of a beam unit in a separating mode of the beam unit and the automated thermal joining of the two remaining parts of the carrier body at the formed joining interface is carried out by means of a beam of the same beam unit in a joining mode of the beam unit, wherein the beam unit is switched from the separating mode into the joining mode for the thermal joining.

The method according to the invention can advantageously be carried out using a separating-joining device designed according to the invention.

The method according to the second aspect of the invention therefore has the same advantages as have already been described for the separating-joining device according to the first aspect of the invention.

According to a third aspect, the present invention discloses a use of a single beam unit for thermally separating a carrier body at at least two definable separating interfaces of the carrier body by means of a beam of the beam unit for sorting out at least one defective component from a plurality of components arranged in series on the carrier body in a longitudinal direction of the carrier body, and for thermally joining a joining interface formed by two remaining parts of the carrier body by means of a beam of the beam unit.

The beam unit (as a single device) therefore in particular has all components which a thermal ablation unit for the thermal separation has and also which a welding unit for the thermal joining has. In other words, the beam unit is to be understood as a two-in-one beam unit. By switching between the separating mode and the joining mode, the beam unit can be used for thermally joining two remaining parts of the carrier body at a joining interface and also for thermally separating the carrier body at separating interfaces.

The use according to the third aspect of the invention therefore has the same advantages as have already been described for the separating-joining device according to the first aspect of the invention and the method according to the second aspect of the invention.

Further measures improving the invention result from the following description of several exemplary embodiments of the invention, which are schematically shown in the figures. All features and/or advantages, including constructive details, spatial arrangements, and method steps, arising from the claims, the description, or the drawings can be essential to the invention both as such and in the various combinations. It is to be noted that the figures only have descriptive character and are not intended to restrict the invention in any form.

### FIGURES

In the schematic figures:

FIG. 1 shows a separating-joining device,

FIG. 2 shows a separating-joining device, and

FIG. 3 shows a method.

### EXEMPLARY EMBODIMENTS

In the following figures, identical reference signs are used for identical technical features, even from different exemplary embodiments.

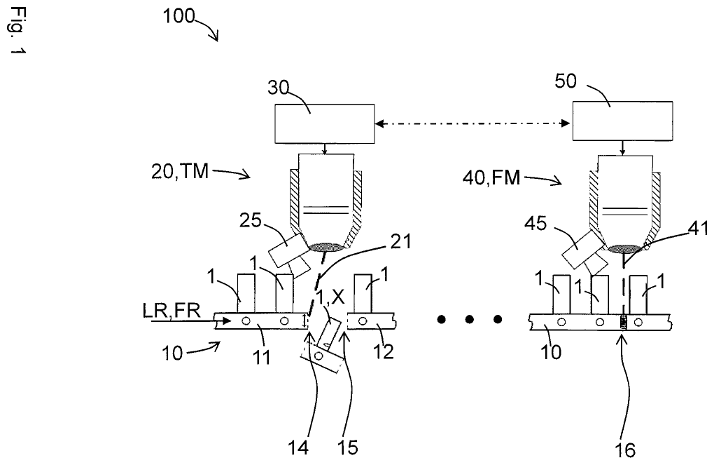

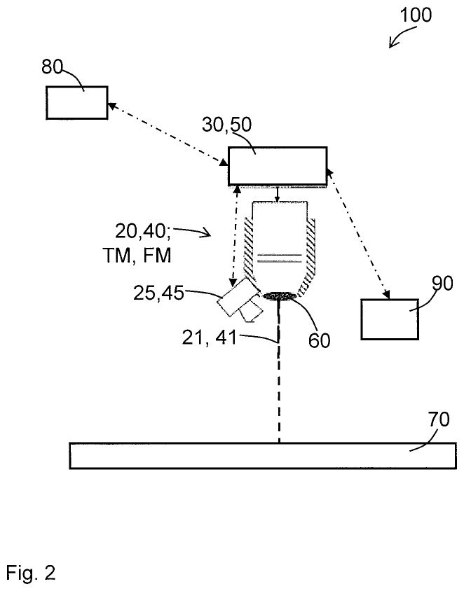

FIG. 1 schematically discloses a separating-joining device 100 for separating and for joining a carrier body 10, wherein the separating-joining device 100 is designed for sorting out, in particular for automated sorting out, of at least one defective component X from a plurality of components 1 arranged in series on the carrier body 10 in a longitudinal direction LR of the carrier body 10. The separating-joining device 100 comprises a thermal ablation unit 20 for thermally separating the carrier body 10 by means of a beam 21 at separating interfaces 14, 15. In FIG. 1, a recheck part having the defective component X has been separated out by the thermal ablation unit 20. Furthermore, the separating-joining device 100 comprises a welding unit 40 downstream from the ablation unit 20 in the advancing direction FR of a conveyor unit (not shown; see FIG. 2, for example) for thermally joining the carrier body 10 by means of a beam 41. In addition, the separating-joining device 100 comprises an ablation supervision unit 30 for supervising the thermal ablation unit 20, wherein the ablation supervision unit 30 is designed to supervise the thermal ablation unit 20 in an automated manner such that the carrier body 10 is thermally separated at at least two definable separating interfaces 14, 15 of the carrier body 10 for sorting out the at least one defective component X in a separating mode TM of the thermal ablation unit 20 by the beam 21 of the thermal ablation unit 20. In addition, the separating-joining device 100 comprises a drivable conveyor unit (not shown; see FIG. 2, for example, conveyor unit 70) for moving the at least two remaining parts 11, 12 of the carrier body 10 for concatenating the two separating interfaces 14, 15 of the two remaining parts 11, 12 of the carrier body 10 to form a joining interface 16 of the two remaining parts 11, 12 of the carrier body 10. In addition, the separating-joining device 100 comprises a welding supervision unit 50 for supervising the welding unit 40, wherein the welding supervision unit 50 is designed to supervise the welding unit 40 in an automated manner such that the two remaining parts 11, 12 of the carrier body 10 are thermally joined together by the beam 41 of the welding unit 40 at the joining interface 16 in a joining mode FM of the welding unit 40. In FIG. 1, the two remaining parts 11, 12 are joined together at the joining interface 16 by the welding unit 40 by means of the beam 41 to form the carrier body 10 having perfect components 1 in at least some sections. In particular, the thermal ablation unit 20 is a laser ablation unit and/or the laser welding unit 40 is a laser welding unit. Furthermore, the thermal ablation unit 20 can additionally comprise a first optical sensor unit 25 for optically detecting the two separating interfaces 14, 15 and/or the welding unit 40 can have a second optical sensor unit 45 for optically detecting the joining interface 16 formed by the two remaining parts 11, 12. Furthermore, the drivable conveyor unit (not shown; see FIG. 2, for example) can have a normal mode and a concatenation mode, wherein the at least one drivable conveyor unit, in the normal mode, moves the carrier body 10 having the components 1 arranged in series on the carrier body 10 in the longitudinal direction LR of the carrier body 10 in advancing direction FR, and wherein the at least one drivable conveyor unit is furthermore designed, in the concatenation mode, to move the two remaining parts 11, 12 of the carrier body 10 toward one another (see remaining parts 11, 12 of the carrier body at the thermal ablation unit 20) to form the joining interface 16. The conveyor unit can have drives controllable independently of one another for moving the two remaining parts 11, 12 toward one another.

FIG. 2 schematically discloses a separating-joining device 100, as has already been described in particular for FIG. 1, wherein in comparison to FIG. 1, the ablation supervision unit 30 and the welding supervision unit 40 are the same supervision unit, i.e. a single supervision unit, and wherein the thermal ablation unit 20 and the welding unit 40 are the same beam unit, i.e. a single beam unit, wherein the beam unit is switchable at least between the separating mode TM for the thermal separation of the carrier body 10 and the joining mode FM for the thermal joining of the carrier body 10. In other words, the separating-joining device 100 has a single beam unit for the thermal separation of the carrier body 10 (not shown) by means of a beam 21, in particular a laser beam, and for the thermal joining of the carrier body (10) by means of a beam 41, in particular a laser beam, as well as a single supervision unit 30, 50 for supervising the beam 21 for the thermal separation or the beam 41 for the thermal joining. In particular, the thermal separation is carried out by means of a pulsed beam 21, in particular by means of a pulsed laser beam. The thermal joining is preferably carried out by means of a beam 41 moved in a curve, in particular by means of a pulsed laser beam moved in a curve. The beam unit in particular furthermore has a focusing optical unit 60 for focusing the beam 21 or the beam 41, wherein in particular the focusing optical unit 60 is arranged at a beam exit end of the beam unit, and wherein in particular the beam exit end of the beam unit faces toward the carrier body 10 (not shown; cf. FIG. 1 in this regard) having the components 1 arranged on the carrier body 10. At the beam exit end of the beam unit, the beam exits from the beam unit toward the carrier body 10 having the components 1 arranged on the carrier body 10. Furthermore, in particular an optical sensor unit 25, 45 for optically detecting the separating interfaces 14, 15 and for optically detecting the at least one joining interface 16 can be arranged at an arrangement interface formed on an outer lateral surface of the beam unit. The optical sensor unit 25, 45 is preferably arranged at the outer lateral surface of the beam unit at the beam exit end of the beam unit. Furthermore, the separating-joining device 100 additionally comprises a component sensor device 80 for detecting at least the plurality of components 1 arranged in series in the longitudinal direction LR of the carrier body 10 for ascertaining the at least one defective component X. The component sensor device 80 is in particular arranged upstream from the beam unit. Furthermore, the separating-joining device 100 additionally comprises a removal unit 90, in particular a pneumatic removal unit, for improved removal of the carrier body part separated at the two separating interfaces 14, 15 together with the defective component X (cf. FIG. 1 in this regard) arranged on the carrier body part. Furthermore, in FIG. 2, the optical sensor device 25, 45 in the component sensor device 80 and the removal unit 90 and the beam unit 20, 40 each have a communication connection to the supervision unit 30, 50.

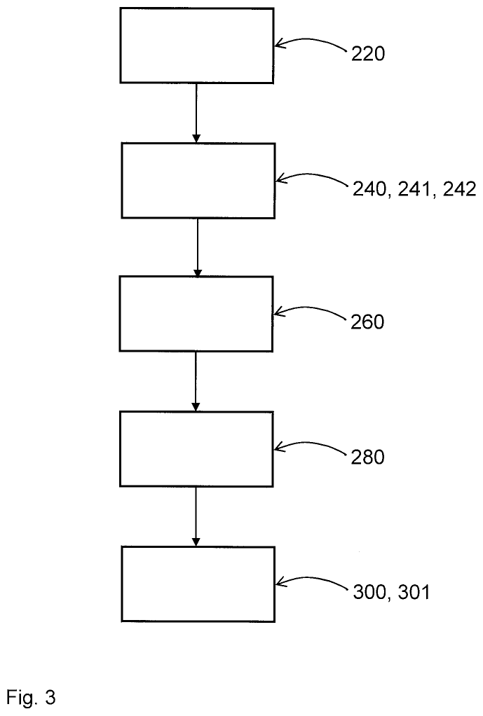

FIG. 3 discloses a method for sorting out at least one defective component X from a plurality of components 1 arranged in series on the carrier body 10 in a longitudinal direction LR of the carrier body 10. The method comprises as a first step ascertaining 220 the at least one defective component X from the plurality of components 1 arranged in series on the carrier body 10 in the longitudinal direction LR of the carrier body 10. As a further step, the method comprises automatically defining 240 at least two separating interfaces 14, 15 of the carrier body 10 based on the at least one ascertained defective component X. For example, a center can be defined in each case between two adjacent components as a separating interface. In particular, adjacent components 1 of the plurality of components 1 arranged in series on the carrier body 10 in the longitudinal direction LR of the carrier body 10 can each have the same or essentially the same distance, wherein the two separating interfaces 14, 15 of the carrier body 10 are defined 241 in each case based on the ascertained defective component X such that after the thermal joining of the carrier body 10 at the joining interface 16 formed by the two remaining parts 11, 12, adjacent components 1 still each have the same or essentially the same distance. Furthermore, in addition the at least two separating interfaces 14, 15 of the carrier body 10 can be defined 242 based on the ascertained defective component X such that only the carrier body 10 having the defective component X arranged on the carrier body 10 is thermally separated out 260. Furthermore, the method comprises as a further step automated thermal separation 260 of the carrier body 10 at the at least two defined separating interfaces 14, 15 of the carrier body 10 to sort out the at least one defective component X by means of a beam. As a further step, the method comprises concatenating 280 the two separating interfaces 14, 15 of the at least two remaining parts 11, 12 of the carrier body 10 to form at least one joining interface 16 of the two remaining parts 11, 12 of the carrier body 10. In addition, the method comprises as a step automated thermal joining 300 of the two remaining parts 11, 12 of the carrier body 10 at the formed joining interface 16 by means of a beam. In particular, the carrier body 10 can be thermally joined 301 at the joining interface 16 formed by the two remaining parts 11, 12 by means of a curved movement, in particular a wobble movement or a zigzag movement, of the beam. In particular, after the thermal joining 300, 301 of the two remaining parts 11, 12, and image for documentation of the weld seam can furthermore be stored.

### LIST OF REFERENCE SIGNS

X defective component
LR longitudinal direction
FR advancing direction of carrier body
TM separating mode
FM joining mode
1 component
10 carrier body
11, 12 remaining parts
14, 15 separating interfaces
16 joining interface
20 thermal ablation unit
21 beam of the thermal ablation unit
25 first optical sensor unit
30 ablation supervision unit
40 welding unit
41 beam of the thermal welding unit
45 second optical sensor unit
50 welding supervision unit
60 focusing optical unit
70 conveyor unit
80 component sensor device
90 removal unit
100 separating-joining device
220 ascertaining defective component
240, 241, 242 automated defining of separating interfaces
260 automated thermal separation of the carrier body
280 concatenating the two separating interfaces
300, 301 automated joining at the joining interface

1. A separating-joining device for separating and for joining a carrier body, wherein the separating-joining device is designed for sorting out at least one defective component (X) from a plurality of components arranged in series on the carrier body in a longitudinal direction (LR) of the carrier body, wherein the separating-joining device comprises:
at least one thermal ablation unit for thermally separating the carrier body via a beam;
at least one welding unit for thermally joining the carrier body via a beam;
an ablation supervision unit for supervising the thermal ablation unit, wherein the ablation supervision unit is designed to supervise the thermal ablation unit in an automated manner such that the carrier body is thermally separated at at least two definable separating interfaces of the carrier body for sorting out the at least one defective component (X) in a separating mode (TM) of the thermal ablation unit by the beam of the thermal ablation unit;
at least one drivable conveyor unit for moving the at least two remaining parts of the carrier body for concatenating the two separating interfaces of the two remaining parts of the carrier body to form a joining interface of the two remaining parts of the carrier body; and
a welding supervision unit for supervising the welding unit, wherein the welding supervision unit is designed to supervise the welding unit in an automated manner such that the two remaining parts of the carrier body are thermally joined together in a joining mode (FM) of the welding unit at the joining interface by the beam of the welding unit.

2. The separating-joining device as claimed in claim 1, wherein
the ablation supervision unit and the welding supervision unit are the same supervision unit, and wherein the thermal ablation unit and the welding unit are the same beam unit, wherein the beam unit is switchable at least between the separating mode (TM) for thermally separating the carrier body and the joining mode (FM) for thermally joining the carrier body.

3. The separating-joining device as claimed in claim 1, wherein the ablation unit is a laser ablation unit, wherein the thermal separation of the carrier body at the at least two separating interfaces of the carrier body is carried out in each case via a laser beam and/or that the welding unit is a laser welding unit, wherein the thermal joining of the carrier body at the joining interface formed by the two remaining parts is carried out via a laser beam.

4. The separating-joining device as claimed in claim 1, wherein the separating-joining device has a first clamping unit for clamping the carrier body for the thermal separation of the carrier body at the at least two separating interfaces of the carrier body for sorting out the at least one defective component and/or that the separating-joining device has a second clamping unit for clamping the carrier body for the thermal joining at the joining interface formed by the two remaining parts.

5. The separating-joining device as claimed in claim 1, wherein the thermal ablation unit has a first optical sensor unit for optically detecting the at least two separating interfaces, wherein the ablation supervision unit is furthermore designed to supervise the beam of the thermal ablation unit for the thermal separation with the aid of the first optical sensor unit and/or to monitor the beam of the thermal ablation unit with the aid of the first optical sensor unit and/or to check the at least two separating interfaces with the aid of the first optical sensor unit and/or that the welding unit has a second optical sensor unit for optically detecting the joining interface formed by the two remaining parts, wherein the welding supervision unit is furthermore designed to supervise the beam of the welding unit with the aid of the second optical sensor unit and/or to monitor the beam of the welding unit with the aid of the second optical sensor unit and/or to check the joint formed by the two remaining parts with the aid of the second optical sensor unit.

6. The separating-joining device as claimed in claim 5, wherein the first optical sensor unit and the second optical sensor unit are the same optical sensor unit.

7. The separating-joining device as claimed in claim 1, wherein the separating-joining device has a component sensor device for detecting at least the plurality of components arranged in series in the longitudinal direction of the carrier body for ascertaining the at least one defective component.

8. The separating-joining device as claimed in claim 1, wherein the separating-joining device has a removal unit for removing the carrier body part separated out at the two separating interfaces together with the defective component arranged on the carrier body part.

9. The separating-joining device as claimed in claim 1, wherein the at least one drivable conveyor unit has at least one normal mode and one concatenation mode, wherein the at least one drivable conveyor unit, in the normal mode, moves the carrier body having the components arranged in series on the carrier body in the longitudinal direction of the carrier body in an advancing direction, and wherein the at least one drivable conveyor unit is designed, in the concatenation mode, to move the two remaining parts of the carrier body toward one another to form the joining interface.

10. A method for sorting out at least one defective component from a plurality of components arranged in series on the carrier body in a longitudinal direction of the carrier body, wherein the method comprises:
ascertaining the at least one defective component from the plurality of components arranged in series on the carrier body in the longitudinal direction of the carrier body;
automated defining of at least two separating interfaces of the carrier body based on the at least one ascertained defective component;
automated thermal separating of the carrier body at the at least two defined separating interfaces of the carrier body to sort out the at least one defective component via a beam;
concatenating the two separating interfaces of the at least two remaining parts of the carrier body to form at least one joining interface of the two remaining parts of the carrier body; and
automated thermal joining of the two remaining parts of the carrier body at the form joining interface via a beam.

11. The method as claimed in claim 10, wherein adjacent components of the plurality of components arranged in series on the carrier body in the longitudinal direction of the carrier body each have the same distance, wherein the at least two separating interfaces of the carrier body are defined based on the ascertained defective component such that after the thermal joining of the carrier body at the joining interface formed by the two remaining parts, adjacent components still each have the same distance.

12. The method as claimed in claim 10, wherein the at least two separating interfaces of the carrier body are defined based on the ascertained defective component such that only the carrier body having the defective component arranged on the carrier body is thermally separated out.

13. The method as claimed in claim 10, wherein the carrier body is thermally joined at the joining interface formed by the two remaining parts via a curved movement.

14. The method as claimed in claim 10, wherein the beam for thermally separating the carrier body at at least one of the two defined separating interfaces of the carrier body is at least temporarily a pulsed beam and/or that the beam for thermally joining at the joining interface formed by the two remaining parts is at least temporarily a continuous beam and/or is at least temporarily a pulsed beam moved in a curve along the joining interface.

15. The method as claimed in claim 10, wherein multiple defective components are thermally separated out from the components arranged in series on the carrier body in the longitudinal direction of the carrier body by thermally separating the carrier body at defined separating interfaces of the carrier body, wherein chronologically after the separating out of the multiple defective components, the carrier body is thermally joined at multiple joining interfaces.

16. The method as claimed in claim 10, wherein the method is carried out using a separating-joining device.

17. A single beam unit:
for thermally separating a carrier body at least two definable separating interfaces of the carrier body via a beam for sorting out at least one defective component from a plurality of components arranged in series on the carrier body in a longitudinal direction of the carrier body; and
for thermally joining a joining interface formed by two remaining parts of the carrier body via a beam.
